(19) United States
(12) Patent Application Publication
(10) Pub. No.: US 2010/0196562 A1
(43) Pub. Date: Aug. 5, 2010

(54) METHOD OF TREATMENT OF FRESH PRODUCE

(76) Inventor: Gil Depicciotto, Zichron Yaacov (IL)

Correspondence Address: LADAS & PARRY LLP, 224 SOUTH MICHIGAN AVENUE, SUITE 1600, CHICAGO, IL, 60604, US

(21) Appl. No.: 12/677,407

(22) PCT Filed: Aug. 13, 2008
(86) PCT No.: PCT/IL08/01113

§ 371 Date: Apr. 22, 2010

Related U.S. Application Data
(63) Continuation-in-part of application No. 11/852,564, filed on Sep. 10, 2007.

(51) Int. Cl. A23B 7/015; A23B 7/06; A23L 1/212

(52) U.S. Cl. 426/244; 426/509; 426/615; 426/248; 426/392

(57) ABSTRACT

A method of treatment of fresh produce including blanching fresh produce, rapid cooling of the fresh produce following the blanching, and packaging the fresh produce following the rapid cooling.

### FIELD OF THE INVENTION

The present invention relates to methods and systems for preparation of “fresh cut” produce.

### BACKGROUND OF THE INVENTION

The following U.S. patents are believed to represent the current state of the art:

U.S. Pat. Nos. 6,821,540; 5,843,511; 5,645,879; 5,599,572; 4,957,761; 4,933,411; 4,832,969 and 3,997,678.

### SUMMARY OF THE INVENTION

The present invention seeks to provide improved methods and systems for the preparation of “fresh cut” produce. “Fresh cut” produce refers to produce which is sold and intended to be consumed in a fresh state.

There is thus provided in accordance with a preferred embodiment of the present invention a method of treatment of fresh produce including blanching fresh produce, rapid cooling of the fresh produce following the blanching, and packaging the fresh produce following the rapid cooling.

There is also provided in accordance with another preferred embodiment of the present invention a packaged fresh produce product produced by a method including blanching fresh produce, rapid cooling of the fresh produce following the blanching, and packaging the fresh produce following the rapid cooling.

Preferably, the rapid cooling includes cooling the fresh produce in water. Preferably, the method also includes electrolyzing the water when the fresh produce is located therein. Additionally or alternatively, the method also includes application of UV radiation to the water containing the fresh produce.

Preferably, the electrolyzing produces free chlorine.

Preferably, the electrolyzing provides anti-microbial activity.

Preferably, the blanching includes blanching in water at approximately 100 degrees Centigrade for 3-5 seconds. Alternatively, the blanching includes blanching in steam at approximately 121 degrees Centigrade for about 2 seconds.

Preferably, the packaging includes packaging in a controlled atmosphere. Additionally, the controlled atmosphere includes about 70% Nitrogen and about 30% CO₂.

Preferably, the rapid cooling includes rapid cooling in circulating water at a temperature of between 0 degrees Centigrade and 4 degrees Centigrade. Additionally, the rapid cooling includes rapid cooling in the circulating water for between 15 and 20 minutes.

### BRIEF DESCRIPTION OF THE DRAWINGS

The present invention will be understood and appreciated more fully from the following detailed description, taken in conjunction with the drawings in which:

FIG. 1 is a simplified illustration of a system and methodology for preparation of “fresh cut” produce in accordance with a preferred embodiment of the present invention; and

FIG. 2 is a simplified illustration of a rapid cooling stage employing water which is UV treated and electrolyzed in accordance with a preferred embodiment of the present invention.

### DETAILED DESCRIPTION OF A PREFERRED EMBODIMENT

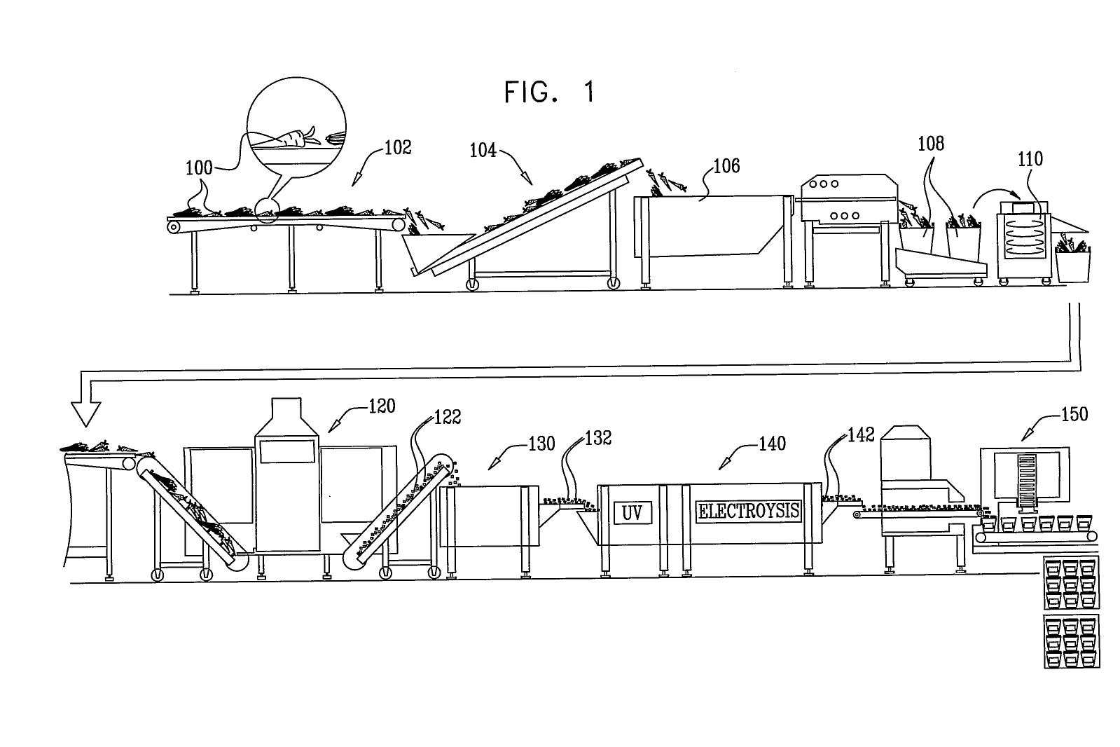

Reference is now made to FIG. 1, which is a simplified illustration of a system and methodology for preparation of “fresh cut” produce in accordance with a preferred embodiment of the present invention. As seen in FIG. 1, quality selected fresh produce 100, such as, for example, celery, carrots, kohlrabi, red pepper and cucumber, is conveyed from a sorting table 102 by an elevator 104 to a washing stage 106, at which the produce is washed, preferably employing air jets and circulating water in a conventional manner. Downstream of washing stage 106, the produce 100 is typically placed into baskets 108, which are in turn placed into a drying centrifuge 110, which dries the produce without heating it.

The washed and dried produce may then be stored under appropriate conditions or directly supplied to a cutting stage 120, which may include, for example, a stick cutter or a strip cutter. The apparatus described hereinabove, including sorting table 102, elevator 104, washing stage 106, baskets 108, drying centrifuge 110 and cutting stage 120, which may include, for example, a stick cutter or a strip cutter, are all commercially available from Kronen GmbH & Co. KG of Willstatt, Germany and from Eillert of Ulft, Holland.

Washed, dried and cut produce 122 from the cutting stage 120 is preferably supplied to a blanching stage 130, which is commercially available from Femia Industrie of Nanterre, France. Preferably blanching takes place in water at approximately 100 degrees Centigrade for 3-5 seconds or in steam at approximately 121 degrees Centigrade for about 2 seconds. Blanching of “fresh cut” produce as described hereinabove, followed by rapid cooling thereof, is a particular feature of the present invention.

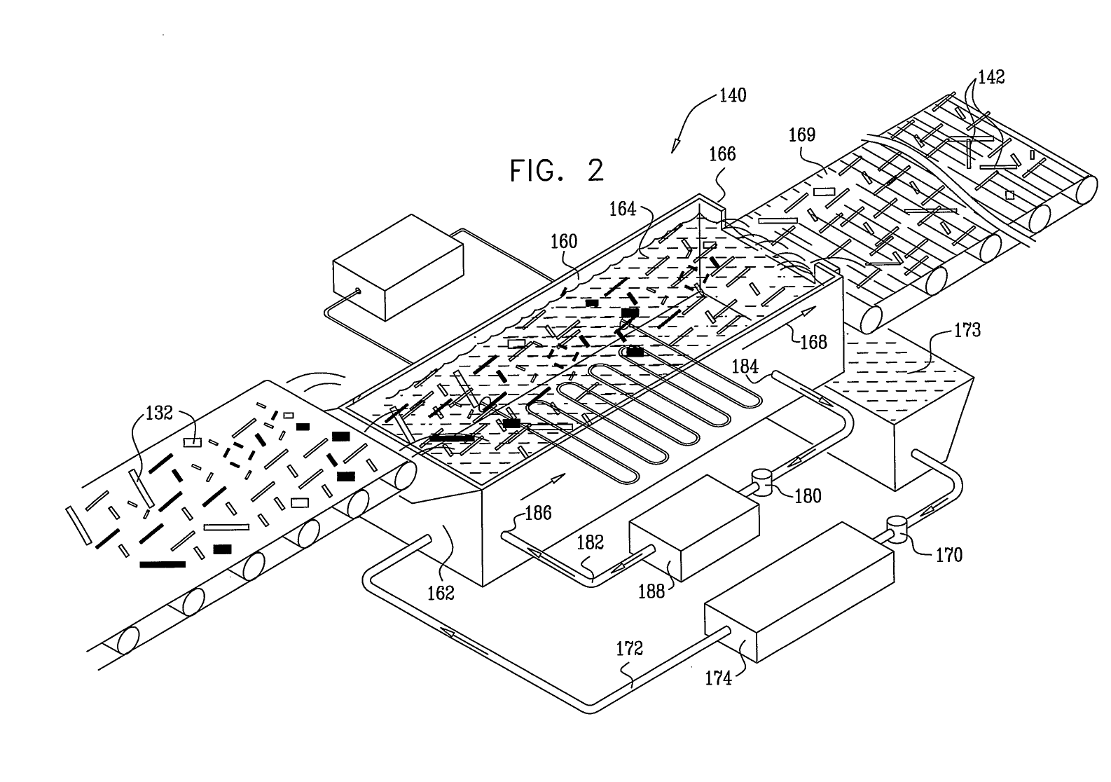

Downstream of blanching stage 130, washed, dried, cut and blanched produce 132 is supplied to a rapid cooling stage 140, employing water which is UV treated and electrolyzed in accordance with a preferred embodiment of the present invention. A preferred embodiment of rapid cooling stage 140 is illustrated in FIG. 2. Downstream of the rapid cooling stage 140, the washed, dried, cut, blanched and rapid cooled produce 142 is supplied to a packaging stage 150 at which it is packed in sealed plastic containers in a controlled atmosphere, preferably 70% Nitrogen and 30% CO₂. The packaging stage 150 is commercially available from Hefestus Ltd. of Ceasaria, Israel.

Turning now additionally to FIG. 2, it is appreciated that a particular feature of the present invention is rapid cooling of the produce using circulating water which is treated concurrently by at least one, and preferably both, of UV and electrolysis. As seen in FIG. 2, the rapid cooling stage 140 includes a bath 160 which receives, at a first end 162 thereof, the washed, dried, cut and blanched produce 132. The bath 160 is filled with circulating water 164, at a temperature of between 0 degrees Centigrade and 4 degrees Centigrade, which circulates, from first end 162 to a second end 166 of bath 160, in a direction indicated by an arrow 168, carrying the produce 132 with it. The residence time of the produce 132 in bath 160 is typically between 15 and 20 minutes. Upon leaving bath 160 at second end 166, the produce 132 together with the water driving it, engages a filtering conveyor 169, which allows the water to be drained from the produce.

A first circulation pump 170, preferably located along a fluid flow conduit 172 communicating between a water drain 173 at filtering conveyor 169 and end 162 of bath 160 drives water from the filtering conveyor 169 back to first end 162, via a UV treatment stage 174, preferably a UV Hydro-Optic Disinfection Unit commercially available from Atlantium Technologies Ltd. of Bet Shemesh, Israel.

A second circulation pump 180, preferably located along a fluid flow conduit 182 communicating between locations 184 and 186 of bath 160 circulates water via a electrolysis treatment stage 188, preferably a UET disinfection unit, such as a UET-D available from Universal Environmental Technology, P.O. Box 3006, Omer, Israel.

The electrolysis treatment stage 188 renders anti-microbial activity to regular tap water, without addition of any exogenous chemicals and without changing its physic-chemical parameters, such as pH, based on partial electrolysis of water. The electrolysis treatment stage 188 includes an electrical cell, comprising a cathode, an anode and a DC converter electrical board.

Several known parameters influence the biocide effect of electrolysis treatment stage 188, including distance between the anode and the cathode (1), water velocity in the system, diameter of the anode and cathode, length of the anode and cathode and power supply (intensity, voltage).

The electrolysis treatment stage 188 preferably provides for generation of biocide species as described further hereinbelow. The reactions taking place during the electrolysis treatment stage 188 are partly represented in Table 1. Water passes through electrolysis treatment stage 188 and is dissociated into H⁺ and OH⁻. The H⁺ drives the activation of the following potentially active elements in the water: dissolved Cl⁻ and other halide ions and dissolved oxygen and part of the H₂O molecules.

The electrolysis results in formation of potent oxidants, possessing biocide activity: active chlorine, ozone and hydrogen peroxide. The proportion of the active elements (chlorine, ozone and peroxide) in the electrolysis treated water is a direct function of the initial amount of the dissolved Cl⁻.

Since the electrolysis treated water maintains its pH close to neutral, the active chlorine is present mainly in the most active form of hypochlorous acid, HOCl.

The effect of H⁺-driven inter-conversion between Cl⁻, O₂, H₂O and Cl₂, O₃, H₂O₂ is emphasized by the special design of the electrolysis treatment stage 188, comprising a number of engineering and chemical parameters. These parameters include rates of water flow into the electrolysis treatment stage 188 and within the electrolysis treatment stage 188, residence time, anode and cathode areas, distance between anode and cathode, electrical current, equipment volume, water pH and temperature, etc.

TABLE 1
Chemical reactions taking place in the
electrolysis treatment stage 188
Cathodic electrochemical reactions:

| | |
|---|---|
| 2H⁺ + 2e− → H₂ | Hydrogen evolution |
| ½ O₂ + H₂O + 2e− → 2OH⁻ | Oxygen reduction |
| Me^{+z} + Ze → Me | Metal deposition |

Anodic electrochemical reactions:

| | |
|---|---|
| 2OH⁻ − 2e− →2OH⁰ | Formation of OH⁰ radical |
| 2OH⁰ → H₂O + O⁰ | Formation of O⁰ radical |
| 2OH⁰ → H₂O₂ | Formation of hydrogen |
| | peroxide |
| O⁰ + O₂ → O₃ | Ozone evolution |
| 2HCO₃⁻ − 2e− → H₂O + 2CO₂ + ½ O₂ | Carbon dioxide evolution |

Formation of active halide species:

| | |
|---|---|
| 2Cl⁻ − 2e− → 2Cl⁰ | Formation of Cl⁰ radical |
| 2Cl⁰ → Cl₂ | Formation of free chlorine |
| Cl₂ + OH⁻ → HOCl + Cl⁻ | Formation of hypo- |
| | chlorous acid |

The following describes the efficacy of the electrolysis treatment method at low chlorine levels in laboratory and experimental field trials.

It has been shown experimentally that water treated by the electrolysis treatment stage 188 demonstrates strong anti-microbial activity with much lower chlorine levels than in the case of exogenous chemical disinfectant solutions, such as sodium or calcium hypochlorites. The factor is usually about 10, i.e. the anti-microbial activity of the electrolysis treatment stage 188 treated water containing 5 ppm of free chlorine at least equals the activity of bleach (sodium hypochlorite) solution with 50 ppm free chlorine.

When exogenous sources of active chlorine are used (usually sodium or calcium hypochlorites), the amount of added materials has to exceed the above minimal level by 10 to 100 times, i.e. 50 to 200 ppm (hyperchlorination) in order to maintain the concentration of active chlorine in the solution on the effective level. Hyperchlorination is needed because of continuous degradation of exogenous active chlorine due to its interaction with organic matter, as well as limitations of hypochlorites solubility in water and activity fluctuations related to pH changes.

In contrast, the electrolysis treatment stage 188 process provides constant supply of in situ generated water-dissolved active chlorine. The system does not necessitate the addition of any exogenous chemical. No hyperchlorination is needed, and maximal biocide effect is achieved and maintained at low chlorine level. Low chlorine level in the electrolysis treatment stage 188 treated water allows fast elimination of the active species from the solution after termination of the electrochemical process.

It will be appreciated by persons skilled in the art that the present invention is not limited by what has been particularly shown and described hereinabove. Rather the scope of the present invention includes both combinations and subcombinations of features recited in the claims as well as modifications thereof which would occur to a person of ordinary skill in the art upon reading the foregoing and which are not in the prior art.

1. A method of treatment of fresh produce comprising:
blanching fresh produce;
rapid cooling of said fresh produce following said blanching; and
packaging said fresh produce following said rapid cooling.

2. A method of treatment of fresh produce according to claim 1 and wherein said rapid cooling comprises cooling said fresh produce in water.

3. A method of treatment of fresh produce according to claim 2 and also comprising electrolyzing said water when said fresh produce is located therein.

4. A method of treatment of fresh produce according to claim 3 and also comprising application of UV radiation to said water containing said fresh produce.

5. A method of treatment of fresh produce according to claim 3 and wherein said electrolyzing produces free chlorine.

6. A method of treatment of fresh produce according to claim 3 and wherein said electrolyzing provides anti-microbial activity.

7. A method of treatment of fresh produce according to claim 2 and also comprising application of UV radiation to said water containing said fresh produce.

8. A method of treatment of fresh produce according to claim 1 and wherein said blanching comprises blanching in water at approximately 100 degrees Centigrade for 3-5 seconds.

9. A method of treatment of fresh produce according to claim 1 and wherein said blanching comprises blanching in steam at approximately 121 degrees Centigrade for about 2 seconds.

10. A method of treatment of fresh produce according to claim 1 and wherein said packaging comprises packaging in a controlled atmosphere.

11. A method of treatment of fresh produce according to claim 10 and wherein said controlled atmosphere comprises about 70% Nitrogen and about 30% CO₂.

12. A method of treatment of fresh produce according to claim 1 and wherein said rapid cooling comprises rapid cooling in circulating water at a temperature of between 0 degrees Centigrade and 4 degrees Centigrade.

13. A method of treatment of fresh produce according to claim 12 and wherein said rapid cooling comprises rapid cooling in said circulating water for between 15 and 20 minutes.

14. A packaged fresh produce product produced by a method comprising:
blanching fresh produce;
rapid cooling of said fresh produce following said blanching; and
packaging said fresh produce following said rapid cooling.

15. A packaged flesh produce product according to claim 14 and wherein said rapid cooling comprises cooling said fresh produce in water.

16. A packaged fresh produce product according to claim 15 and wherein said method also comprises electrolyzing said water when said fresh produce is located therein.

17. A packaged fresh produce product according to claim 16 and wherein said method also comprises application of UV radiation to said water containing said fresh produce.

18. A packaged fresh produce product to claim 16 and wherein said electrolyzing produces free chlorine.

19. A packaged fresh produce product according to claim 16 and wherein said electrolyzing provides anti-microbial activity.

20. A packaged fresh produce product according to claim 14 and wherein said blanching comprises at least one of blanching in water at approximately 100 degrees Centigrade for 3-5 seconds and blanching in steam at approximately 121 degrees Centigrade for about 2 seconds.
